(19) United States
(12) Patent Application Publication
(10) Pub. No.: US 2011/0023202 A1
(43) Pub. Date: Feb. 3, 2011

(54) Method For Making a Composite Laminate

(75) Inventors: BRYCE VANARSDALEN, Wilmington, DE (US); Thomas D. Boyer, Clayton, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/843,939

(22) Filed: Jul. 27, 2010

Related U.S. Application Data
(60) Provisional application No. 61/230,822, filed on Aug. 3, 2009.

(51) Int. Cl. F41H 1/02; B29C 43/00; B32B 27/32; A42B 1/06

(52) U.S. Cl. 2/2.5; 264/331.17; 428/221; 2/410

(57) ABSTRACT

This invention covers a method of manufacturing a composite laminate comprising the steps of (a) cutting a plurality of ply shapes from prepreg sheet stock, (b) stacking, in the desired order, the prepreg ply shapes to form a subassembly of from 2 to 8 cut plies, the subassembly further comprising at least 2 different ply shapes, (c) pre-consolidating the subassembly under heat and pressure to form a semi-rigid preform, (d) assembling a plurality of semi-rigid preforms into a mold, and (e) consolidating the plurality of preforms under heat and pressure to form a cured composite laminate. The prepreg plies further comprise from 70 to 92% by weight of a fabric made from continuous yarn having a tenacity of at least 20 grams per dtex and a modulus of at least 550 grams per dtex, and from 8 to 30% by weight of a thermoplastic matrix copolymer blend. The composite laminate is particularly useful as an anti-ballistic hard armor laminate in articles such as helmets and other hard armor products.

### BACKGROUND OF THE INVENTION

1. Field of the Invention

This invention relates to a method of making a composite laminate that is particularly suitable for anti-ballistic helmets and other hard armor applications.

2. Description of the Related Art

U.S. Pat. Nos. 4,953,234 and 5,112,667, both to Li et al. describe an impact resistant helmet comprising an impact resistant composite shell. The composite shell comprises a plurality of prepreg packets.

United States Patent Publication 2008/0142151 to Busch teaches a method for producing a ballistic protective armor by superimposing a certain number of textile layers in such a way that a layer structure is formed, in sewing the textile layers of the layer structure to each other and in pressing the layer structure.

United Kingdom Patent GB 2098852A to Eliezer et al discloses a protective helmet comprising a multiplicity of partially overlapping layers of reinforcing material arranged about a center and molded into a helmet configuration. The partially overlapping layers define a flower configuration of radially extending petals of reinforcing material.

European patent application 0585793A1 to Li et al describes a penetration resistant article of manufacture having at least one surface defined by a plurality of points at least two of said points located in different horizontal planes, said article comprising a plurality of prepreg packets each comprising at least two prepreg layers wherein said layers are comprised of a fibrous network in a polymeric matrix wherein said prepreg layers have been precompressed into prepreg packets at a temperature and pressure sufficient to bond adjacent surfaces of adjacent layers.

### SUMMARY OF THE INVENTION

This invention is directed to a method of manufacturing a composite laminate comprising the steps of:
(a) cutting a plurality of ply shapes from prepreg sheet stock,
(b) stacking, in the desired order, said prepreg ply shapes to form a subassembly of from 2 to 8 cut plies, said subassembly further comprising at least 2 different ply shapes,
(c) pre-consolidating the subassembly at a temperature of from 120° C. to 180° C. and a pressure of from 175 N/m to 3500 N/m for between 1 to 6 minutes to form a semi-rigid preform,
(d) assembling a plurality of semi-rigid preforms into a mold, and
(e) consolidating said plurality of preforms at a temperature of from 105° C. to 190° C. and a pressure of from 0.034 MN/m² to 55 MN/m² for between 1 to 40 minutes to form a composite laminate,
wherein said prepreg plies further comprise
   (i) from 70 to 92% by weight of a fabric made from continuous yarn having a tenacity of at least 20 grams per dtex and a modulus of at least 550 grams per dtex, and
   (ii) from 8 to 30% by weight of a thermoplastic matrix polymer comprising a blend of elastomeric block copolymers and polyethylene copolymers.

### BRIEF DESCRIPTION OF THE DRAWINGS

FIG. 1 represents a cross shaped ply positioned on top of a circular shaped ply.

FIG. 2 represents four cross shaped plies positioned on top of four circular plies.

### DETAILED DESCRIPTION OF THE INVENTION

A prepreg as discussed herein is a ready-to-mold material in sheet form comprising reinforcement fiber in the form of a fabric and a matrix resin, the resin being either on the surface of the fabric, impregnated into the fabric or some combination of both.

A preform is a sub-assembly comprising a plurality of plies (layers) of prepreg that have been cut to shape and partially consolidated to hold the individual plies together.

### Prepreg Fabric

Fabrics suitable for use with this invention include woven, unidirectional, with or without binder, multiaxial, felt or mat. Each of these fabric styles is well known in the art. A woven fabric is preferred. The woven fabric can have essentially any weave such as plain weave, crowfoot weave, basket weave, satin weave, twill weave, unbalanced weaves, and the like. Plain weave is preferred.

In some embodiments, the woven fabric has a basis weight of from 50 to 800 g/m². In some embodiments the basis weight is from 100 to 600 g/m². In some other embodiments the basis weight of the woven fabric is from 130 to 500 g/m².

In some embodiments, the fabric yarn count in the warp is 2 to 39 ends per centimeter (5 to 100 ends per inch), or even 3 to 24 ends per centimeter. (8 to 60 ends/inch). In some other embodiments, the yarn count in the warp is 4 to 18 ends per centimeter (10 to 45 ends/inch). In some embodiments, the fabric yarn count in the weft or fill is 2 to 39 ends per centimeter, (5 to 100 ends per inch), or 3 to 24 ends per centimeter. (8 to 60 ends/inch). In some other embodiments, the yarn count in the weft or fill is 4 to 18 ends per centimeter. (10 to 45 ends/inch).

It is further understood that different combinations of fabrics both in construction and composition can be employed. The fabric comprises from 70 to 92 weight percent of the combined weight of fabric plus matrix resin.

### Fabric Yarns or Filaments

The fabrics are woven from multifilament yarns having a plurality of filaments. For purposes herein, the term “filament” is defined as a relatively flexible, macroscopically homogeneous body having a high ratio of length to width across its cross-sectional area perpendicular to its length. The filament cross section can be any shape, but is typically circular or bean shaped. Preferably, the filaments are continuous.

Yarns having a yarn tenacity of at least 20 grams per dtex and a yarn modulus of at least 550 grams per dtex are well known in the art and are used in this invention. Suitable polymeric materials for the yarn filaments include polyamide, polyolefin, polyazole and mixtures thereof.

When the polymer is polyamide, aramid is preferred. The term “aramid” means a polyamide wherein at least 85% of the amide (—CONH—) linkages are attached directly to two aromatic rings. Suitable aramid fibers are described in Man-Made Fibres—Science and Technology, Volume 2, Section titled Fibre-Forming Aromatic Polyamides, page 297, W. Black et al., Interscience Publishers, 1968.

A preferred aramid is a para-aramid. A preferred para-aramid is poly(p-phenylene terephthalamide) which is called PPD-T. By PPD-T is meant a homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

When the polymer is polyolefin, polyethylene or polypropylene is preferred. The term “polyethylene” means a predominantly linear polyethylene material of preferably more than one million molecular weight that may contain minor amounts of chain branching or comonomers not exceeding 5 modifying units per 100 main chain carbon atoms, and that may also contain admixed therewith not more than about 50 weight percent of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE) or ultra high molecular weight polyethylene (UHMWPE

In some preferred embodiments polyazoles are polyarenazoles such as polybenzazoles and polypyridazoles. Suitable polyazoles include homopolymers and, also, copolymers. Additives can be used with the polyazoles and up to as much as 10 percent, by weight, of other polymeric material can be blended with the polyazoles. Also copolymers can be used having as much as 10 percent or more of other monomer substituted for a monomer of the polyazoles. Suitable polyazole homopolymers and copolymers can be made by known procedures.

Preferred polybenzazoles are polybenzimidazoles, polybenzothiazoles, and polybenzoxazoles and more preferably such polymers that can form fibers having yarn tenacities of 30 gpd or greater. If the polybenzazole is a polybenzothioazole, preferably it is poly(p-phenylene benzobisthiazole). If the polybenzazole is a polybenzoxazole, preferably it is poly(p-phenylene benzobisoxazole) and more preferably poly(p-phenylene-2,6-benzobisoxazole) called PBO.

Preferred polypyridazoles are polypyridimidazoles, polypyridothiazoles, and polypyridoxazoles and more preferably such polymers that can form fibers having yarn tenacities of 30 gpd or greater. In some embodiments, the preferred polypyridazole is a polypyridobisazole. A preferred poly(pyridobisozazole) is poly(1,4-(2,5-dihydroxy)phenylene-2,6-pyrido[2,3-d:5,6-d′]bisimidazole which is called PIPD. Suitable polypyridazoles, including polypyridobisazoles, can be made by known procedures.

### Prepreg Matrix Resin

The matrix resin, which is a thermoplastic resin, comprises from 8 to 30 weight percent of the combined weight of fabric plus matrix resin. A preferred thermoplastic resin type is a blend of elastomeric block copolymers and polyethylene copolymers. In preferred embodiments, the polyethylene copolymers comprise from 50 to 75 weight percent and the elastomeric block copolymers comprise from 25 to 50 weight percent of the resin. The resin may be coated onto the surface of the fabric or impregnated between the yarn filaments by well known prepregging methods such as those described in section 2.9 of “Manufacturing Processes for Advanced Composites” by F. C. Campbell, Elsevier, 2004.

### Preform Manufacture

Prepreg ply shapes are cut from prepreg sheet stock using a knife and template, a cutting die or some other means. One sheet of cut prepreg stock is called a ply. If the prepreg has been kept in cold storage, then the material may need to be warmed up to room temperature before cutting begins. The number of shapes to be cut and the dimensions of the shape will depend on the final design of the composite laminate. Typically, there is more than one ply shape in a preform assembly. Typically, there will be no more than four different shapes in one preform. Exemplary cut ply shapes include, but are not limited to, a circle, oval, cross, square, rectangle, diamond, or chevron.

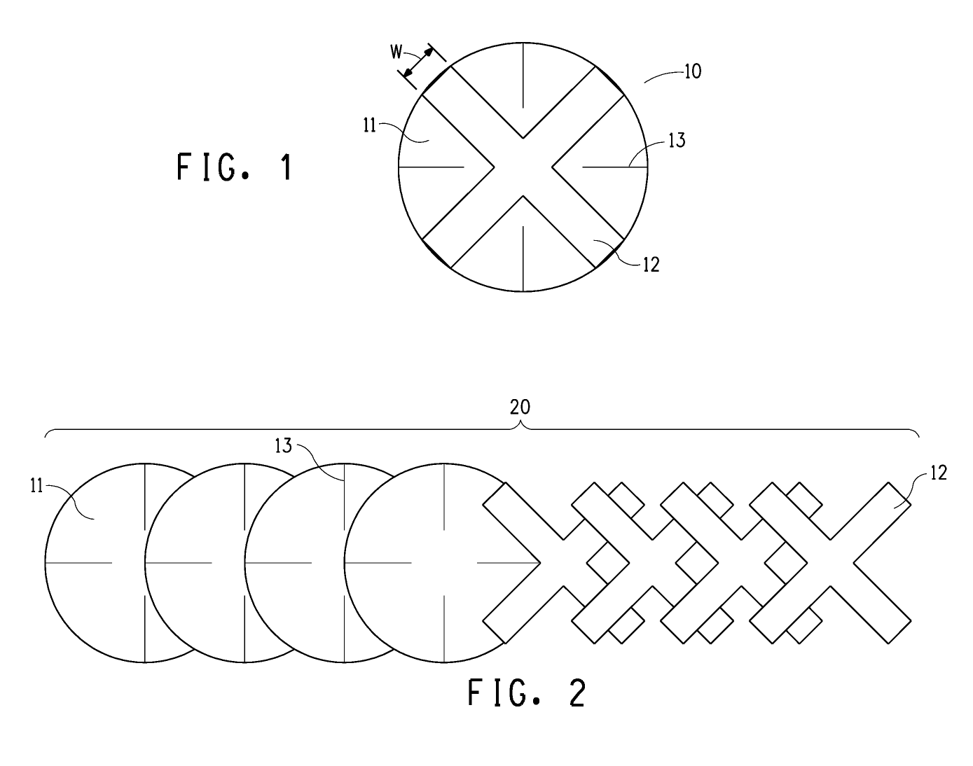

Cut plies are stacked in the desired sequence on a preforming tool, which may be flat or contoured and made of materials such as wood, metal, plastic or ceramic. For some ply shapes, additional cuts or darts may be made in the plies to facilitate assembly in contoured tools. As an example, for a circular ply shape, between two and eight cuts radiating towards the center of the circle may be made. The desired number of plies in a preform is from two to eight and or even from four to eight. In a preferred embodiment, there are two different ply shapes, a cross and a circle. FIG. 1 shows generally at 10 a shape in the form of a cross 12 superimposed on a shape in the form of a circle 11. The circle 11 shows cuts 13, as described above. In one embodiment, different shaped plies can be alternated within the stack. For example, a preform can be made from a circular, a cross shaped and a square shaped ply. In an embodiment, a preform shown generally at 20 in FIG. 2, includes four cross shaped plies 12 stacked on top of four circular shaped plies 11. In a preferred embodiment, the preform comprises an alternating arrangement of circular and cross shaped plies, with a circular ply being the bottom ply. Sewing the plies together prior to placing them in the preforming mold is an optional process. In preferred embodiments, the plies are not sewn. Fasteners are not required to maintain the plies in position in the preforming equipment. To aid assembly of the individual plies into the preform, an ultrasonic bonding tool may be used to tack the plies together.

Pre-consolidation is carried out under temperature and pressure. The temperature can be from 120° C. to 180° C., or from 130° C. to 170° C. or even from 140° C. to 160° C. The pressure can be from 175 N/m to 3500 N/m, or from 875 N/m to 2625 N/m or even from 1400 N/m to 2100 N/m. Once at temperature, the temperature is maintained for a specified number of minutes before cooling is initiated. The temperature hold time can be from 1 min to 6 min, or from 2 min to 5 min or even from 3 min to 4 min. If the stack of plies for preforming is flat, convenient processes for achieving pre-consolidation is calendaring or compaction in a platten press. If the stack of plies for preforming is contoured, convenient processes for achieving pre-consolidation is vacuum bag forming or matched mold shaping. All the above processes are well known in the art. The amount of heat and pressure to pre-consolidate the ply stack should be sufficient to allow the particular thermoplastic to reach a melt stage which permits the polymer to be infused into and through the fabric thus adhering multiple plies together and providing a cohesive and semi-rigid preform. By semi-rigid we mean that the preform is both noticeably stiffer than the prepreg and sufficiently stiff to prevent individual fabric layers from buckling and causing wrinkles during final consolidating in the molding tool. A single preforming step is sufficent to provide the desired compaction and inter-ply coherence to the preform.

### Laminate Manufacture

In preferred embodiments, the final consolidation to produce a molded laminate takes place soon after pre-consolidation of the preform, for example, within 30 minutes. A plurality of preforms are stacked in a desired sequence on a molding tool having the dimensions of the finished article. The tool may be flat or contoured and made of materials such as metal, plastic or ceramic. The desired number of preforms in the final assembly will vary according to the laminate design and the number of plies in each preform. The number of plies in a laminate varies from 2 to 500, or from 20 to 150 or even from 30 to 120. In a preferred embodiment, there are from 7 to 20 preforms in the final assembly with between 3 to 8 cut plies in each preform. Final consolidation is carried out under temperature and pressure. The temperature can be from 105° C. to 190° C., or from 120° C. to 160° C. or even from 140° C. to 150° C. The pressure can be from 0.034 MN/m² to 55 MN/m², or from 7 MN/m² to 34 MN/m² or even from 7 MN/m² to 21 MN/m². Once at temperature, the temperature is maintained for a specified number of minutes before cooling is initiated. The temperature hold time can be from 1 min to 40 min, or from 5 min to 30 min or even from 7 min to 22 min. The molding of the composite laminate may be carried out in a platen press, an autoclave, a matched mold or under vacuum in an oven; such techniques being well known to those skilled in the art. For a thermoplastic matrix resin, the amount of heat required should be sufficient to allow the particular thermoplastic to reach a melt stage. The applied pressure should be sufficient to cause good compaction of the plies such that there are no voids in the finished laminate. Voids may be detected by methods such as ultrasonic scanning or x-rays. Preferably, the finished laminate is removed from the mold after it has cooled to room temperature. This allows the resin to fully solidify before removal from the mold. After removal of the cured laminate from the mold, the laminate is trimmed and sent for finishing operations such as installation of fittings and painting.

### Test Methods

Ballistic Penetration Performance: Ballistic tests of the composite laminate were conducted in accordance with standard procedures MIL STD-662F (V50 Ballistic Test for Armor) and NIJ STD 0106.01 (Ballistic Helmets). Tests were conducted using 17 grain fragment simulating projectiles (FSP's) against the composite laminate targets. The projectiles were compliant with MIL DTL 46593B. Four targets were tested for most examples and between six to nine shots, at zero degree obliquity, fired at each target. The reported V50 values are average values for the number of shots fired for each example. V50 is a statistical measure that identifies the average velocity at which a bullet or a fragment penetrates the armor equipment in 50% of the shots, versus non penetration of the other 50%. The parameter measured is V50 at zero degrees where the degree angle refers to the obliquity of the projectile to the target.

Preform Modulus: Flexural modulus, the ratio of stress to strain in flexural deformation, was measured on samples of preforms having differing numbers of plies. The tests were carried out after pre-consolidation of the preform. The flexural modulus tests were conducted according to ASTM D790-03 and ISO 178, using an Instron test machine having a constant rate of extension. The unit was set up in three point flex mode.

### EXAMPLES

Examples prepared according to the process or processes of the current invention are indicated by numerical values. Control or Comparative Examples are indicated by letters.

Temperature: All temperatures were measured in degrees Celsius (° C.).

In all of the following examples, the prepreg used comprised (a) a plain weave woven fabric of 600 denier (660 dtex) poly(p-phenylene terephthalamide) (or PA) yarn, available from E. I. du Pont de Nemours and Company, Wilmington, Del. (DuPont) under the trade name of Kevlar® para-aramid brand KM2 yarn and was woven at 11.4×11.4 ends per centimeter (29×29 ends per inch) and (b) a 0.038 mm thick thermoplastic matrix resin film which is a blend of elastomeric block copolymers and polyethylene copolymers. The polyethylene copolymers comprise from 50 to 75 weight percent and the elastomeric block copolymers comprise from 25 to 50 weight percent of the resin. Such a film is available from Scott Materials Group Inc., Sioux Falls, S. Dak. The matrix resin content was 16-18% based on the total weight of fabric plus matrix resin. The yarns of the fabric had a nominal yarn tenacity of 28 gpd and a nominal yarn modulus of 630 gpd. The nominal areal weight of the fabric was 182 g/m². Prepreg plies cut in the shape of a circle all had a diameter of 533 mm. Four cuts were made in each circular ply at ninety degree intervals, each cut extending from the circumference of the circle to within 75 mm of the center.

Plies cut in the shape of a cross all had a length of 533 mm and a width, as in W of FIG. 1, of 108 mm. All cross shaped plies were placed to bisect the two adjacent cuts in the underlying circle shaped ply as shown in FIG. 1.

### Example A

Twenty eight plies in the shape of a circle were cut from prepreg stock. A further twenty eight plies in the shape of a cross were also cut from stock. The cross shaped ply was placed on top of the circular ply to form a subassembly comprising 2 plies. Twenty eight such subassemblies were prepared. These subassemblies were not pre-consolidated into a preform. The twenty eight sub assemblies were placed in the final molding tool, the tool having the shape of a helmet, such that there were fifty six plies in the final assembly, the ply arrangement being one of alternating circles and crosses. The final assembly was then consolidated at a temperature of 160 degrees, a pressure of 16 MPa (2300 psi) for 13 minutes, prior to cooling down to room temperature. The composite laminate was then removed from the mold. From a visual examination of the outer surface of the laminate, it was estimated that in excess of 70% of the surface area exhibited wrinkling of the prepreg plies. V50 measurements were obtained and gave a value of 811 m per sec. A second sample of Example A was prepared and tested. From a visual examination of the outer surface of the laminate it was estimated that in excess of 70% of the surface area exhibited wrinkling of the prepreg plies. V50 measurements were obtained and gave a value of 823 m per sec. The average V50 of the two samples was 817 m per sec.

### Example B

Twenty eight plies in the shape of a circle were cut from prepreg stock. A further twenty eight plies in the shape of a cross were also cut from stock. A subassembly comprising ten plies was prepared in which the plies were stacked from bottom to top in the order circle, cross, circle, cross, circle, cross, circle, cross, circle, cross. Five such subassemblies were prepared. An additional subassembly of 6 plies was prepared as per Example 4. Each subassembly was then pre-consolidated at a temperature of 150 degrees for 3 minutes, then a nip pressure of 1751 N/m (10 pli) to produce a semi-rigid preform. The six preforms were placed in the final molding tool, the tool having the shape of a helmet, such that there were fifty six plies in the final assembly with the ply arrangement being one of alternating circles and crosses. In this helmet, the subassembly containing the least amount of plies was placed in the center of the assembly stack. The final assembly of preforms was then consolidated into a composite laminate at a temperature of 160 degrees, a pressure of 16 MPa (2300 psi) for 13 minutes, prior to cooling down to room temperature. The laminate was then removed from the mold. From a visual examination of the outer surface of the laminate it was estimated that less than 10% of the surface area exhibited wrinkling of the prepreg plies. V50 measurements were obtained and gave a value of 806 m per sec.

### Example C

Twenty eight plies in the shape of a circle were cut from prepreg stock. A further twenty eight plies in the shape of a cross were also cut from stock. A subassembly comprising ten plies was prepared in which the plies were stacked from bottom to top in the order circle, circle, circle, circle, circle, cross, cross, cross, cross, cross. Five such subassemblies were prepared. An additional subassembly of six plies was prepared as per Example 5. Each subassembly was then pre-consolidated at a temperature of 150 degrees for 3 minutes, then a nip pressure of 1751 N/m (10 pli) to produce a semi-rigid preform. The six preforms were placed in the final molding tool, the tool having the shape of a helmet, such that there were fifty six plies in the final assembly and the preforms were stacked in an alternating sequence of groups of circles and crosses. In this helmet, the subassembly containing the least amount of plies was placed in the center of the assembly stack. The final assembly of preforms was then consolidated into a composite laminate at a temperature of 160 degrees, a pressure of 16 MPa (2300 psi) for 13 minutes, prior to cooling down to room temperature. The laminate was then removed from the mold. From a visual examination of the outer surface of the laminate, it was estimated that less than 10% of the surface area exhibited wrinkling of the prepreg plies. V50 measurements were obtained and gave a value of 824 m per sec.

### Example 1

Twenty eight plies in the shape of a circle were cut from prepreg stock. A further twenty eight plies in the shape of a cross were also cut from stock. The cross shaped ply was placed on top of the circular ply to form a subassembly comprising 2 plies. Twenty eight such subassemblies were prepared. Each subassembly was then pre-consolidated at a temperature of 150 degrees for 3 minutes, then a nip pressure of 1751 N/m (10 pli) to produce a semi-rigid preform. The twenty eight preforms were placed in the final molding tool, the tool having the shape of a helmet, such that there were fifty six plies in the final assembly, the ply arrangement being one of alternating circles and crosses. The final assembly of preforms was then consolidated into a composite laminate at a temperature of 160 degrees, a pressure of 16 MPa (2300 psi) for 13 minutes prior to cooling down to room temperature. The laminate was then removed from the mold. From a visual examination of the outer surface of the laminate, it was estimated that about 50% of the surface area exhibited wrinkling of the prepreg plies. V50 measurements were obtained and gave a value of 834 m per sec. A second sample of Example 1 was prepared and tested. From a visual examination of the outer surface of the laminate it was estimated that about 50% of the surface area exhibited wrinkling of the prepreg plies. V50 measurements were obtained and gave a value of 813 m per sec. The average V50 of the two samples was 823 m per sec.

### Example 2

Twenty eight plies in the shape of a circle were cut from prepreg stock. A further twenty eight plies in the shape of a cross were also cut from stock. A subassembly comprising four plies was prepared in which the plies were stacked from bottom to top in the order circle, cross, circle, cross. Fourteen such subassemblies were prepared. Each subassembly was then pre-consolidated at a temperature of 150 degrees for 3 minutes, then a nip pressure of 1751 N/m (10 pli) to produce a semi-rigid preform. The fourteen preforms were placed in the final molding tool, the tool having the shape of a helmet, such that there were fifty six plies in the final assembly, the ply arrangement being one of alternating circles and crosses. The final assembly of preforms was then consolidated into a composite laminate at a temperature of 160 degrees, a pressure of 16 MPa (2300 psi) for 13 minutes prior to cooling down to room temperature. The laminate was then removed from the mold. From a visual examination of the outer surface of the laminate, it was estimated that less than 25% of the surface area exhibited wrinkling of the prepreg plies. V50 measurements were obtained and gave a value of 833 m per sec.

### Example 3

Twenty eight plies in the shape of a circle were cut from prepreg stock. A further twenty eight plies in the shape of a cross were also cut from stock. A subassembly comprising four plies was prepared in which the plies were stacked from bottom to top in the order circle, circle, cross, cross. Fourteen such subassemblies were prepared. Each subassembly was then pre-consolidated at a temperature of 150 degrees for 3 minutes, then a nip pressure of 1751 N/m (10 pli) to produce a semi-rigid preform. The fourteen sub assemblies were placed in the final molding tool, the tool having the shape of a helmet, such that there were fifty six plies in the final assembly and the sub-assemblies were stacked in an alternating sequence of groups of circles and crosses. The final assembly of preforms was then consolidated into a composite laminate at a temperature of 160 degrees, a pressure of 16 MPa (2300 psi) for 13 minutes prior to cooling down to room temperature. The laminate was then removed from the mold. From a visual examination of the outer surface of the laminate, it was estimated that less than 25% of the surface area exhibited wrinkling of the prepreg plies. V50 measurements were obtained and gave a value of 841 m per sec.

### Example 4

Twenty eight plies in the shape of a circle were cut from prepreg stock. A further twenty eight plies in the shape of a cross were also cut from stock. A subassembly comprising six plies was prepared in which the plies were stacked from bottom to top in the order circle, cross, circle, cross, circle, cross. Eight such subassemblies were prepared. Two additional subassemblies having four plies each were prepared as per Example 2. Each subassembly was then pre-consolidated at a temperature of 150 degrees for 3 minutes, then a nip pressure of 1751 N/m (10 pli) to produce a semi-rigid preform. The ten preforms were placed in the final molding tool, the tool having the shape of a helmet, such that there were fifty six plies in the final assembly, the ply arrangement being one of alternating circles and crosses. In this helmet, the subassemblies containing the lower number of plies were placed on the top of the assembly stack, corresponding to the inside of the helmet. The final assembly of preforms was then consolidated into a composite laminate at a temperature of 160 degrees, a pressure of 16 MPa (2300 psi) for 13 minutes prior to cooling down to room temperature. The laminate was then removed from the mold. From a visual examination of the outer surface of the laminate it was estimated that less than 15% of the surface area exhibited wrinkling of the prepreg plies. V50 measurements were obtained and gave a value of 836 m per sec.

### Example 5

Twenty eight plies in the shape of a circle were cut from prepreg stock. A further twenty eight plies in the shape of a cross were also cut from stock. A subassembly comprising six plies was prepared in which the plies were stacked from bottom to top in the order circle, circle, circle, cross, cross, cross. Eight such subassemblies were prepared. Two additional subassemblies having four plies each were prepared as per Example 3. Each subassembly was then pre-consolidated at a temperature of 150 degrees for 3 minutes, then a nip pressure of 1751 N/m (10 pli) to produce a semi-rigid preform. The ten preforms were placed in the final molding tool, the tool having the shape of a helmet, such that there were fifty six plies in the final assembly and the preforms were stacked in an alternating sequence of groups of circles and crosses. In this helmet, the subassemblies containing the lower number of plies were placed on the top of the assembly stack, corresponding to the inside of the helmet. The final assembly of preforms was then consolidated into a composite laminate at a temperature of 160 degrees, a pressure of 16 MPa (2300 psi) for 13 minutes prior to cooling down to room temperature. The laminate was then removed from the mold. From a visual examination of the outer surface of the laminate it was estimated that less than 15% of the surface area exhibited wrinkling of the prepreg plies. V50 measurements were obtained and gave a value of 831 m per sec.

### Example 6

Twenty eight plies in the shape of a circle were cut from prepreg stock. A further twenty eight plies in the shape of a cross were also cut from stock. A subassembly comprising eight plies was prepared in which the plies were stacked from bottom top in the order circle, cross, circle, cross, circle, cross, circle, cross. Seven such subassemblies were prepared. Each subassembly was then pre-consolidated at a temperature of 150 degrees for 3 minutes, then a nip pressure of 1751 N/m (10 pli) to produce a semi-rigid preform. The seven preforms were placed in the final molding tool, the tool having the shape of a helmet, such that there were fifty six plies in the final assembly, the ply arrangement being one of alternating circles and crosses. The final assembly of preforms was then consolidated into a composite laminate at a temperature of 160 degrees, a pressure of 16 MPa (2300 psi) units for 13 minutes prior to cooling down to room temperature. The laminate was then removed from the mold. From a visual examination of the outer surface of the laminate, it was estimated that less than 10% of the surface area exhibited wrinkling of the prepreg plies. V50 measurements were obtained and gave a value of 837 m per sec.

### Example 7

Twenty eight plies in the shape of a circle were cut from prepreg stock. A further twenty eight plies in the shape of a cross were also cut from stock. A subassembly comprising eight plies was prepared in which the plies were stacked in the order circle, circle, circle, circle, cross, cross, cross, cross. Seven such subassemblies were prepared. Each subassembly was then pre-consolidated at a temperature of 150 degrees for 3 minutes, then a nip pressure of 1751 N/m (10 pli) to produce a semi-rigid preform. The seven preforms were placed in the final molding tool, the tool having the shape of a helmet, such that there were fifty six plies in the final assembly and the preforms were stacked in an alternating sequence of groups of circles and crosses. The final assembly of preforms was then consolidated into a composite laminate at a temperature of 160 degrees, a pressure of 16 MPa (2300 psi) for 13 minutes prior to cooling down to room temperature. The laminate was then removed from the mold. From a visual examination of the outer surface of the laminate, it was estimated that less than 10% of the surface area exhibited wrinkling of the prepreg plies. V50 measurements were obtained and gave a value of 831 m per sec.

The results of the above examples, including comparatives, are summarized in Table 1. Wrinkles in composite laminates tend to be associated with voids and hence areas of weakness in the structure. They are therefore undesirable. Although Examples 1 and 2 show a 20% reduction in wrinkles, the extent of wrinkling is still relatively high and V50 ballistic improvement is only moderate. Examples 3 through 8 demonstrate significantly lower percentage wrinkle zones, as well as acceptable increases in V50 values. The V50 data in Table 1 shows that pre-consolidation of between three to eight plies into a preform represents an optimization of V50 performance.

TABLE 1

| | | | | | V50 of |
|---|---|---|---|---|---|
| | # Plies in Preform | # Preforms | Total # Plies | % Wrinkles | Laminate |
| Example | Sub-assembly | in Laminate | in Laminate | in Laminate | (m/sec) |
| A | 2 | 28 | 56 | >70% | 817* |
| (no pre- | | | | | |
| consolidation) | | | | | |
| 1 | 2 | 28 | 56 | 50% | 823* |
| 2 | 4 | 14 | 56 | <25% | 833 |
| 3 | 4 | 14 | 56 | <25% | 841 |
| 4 | 6 plus 2 @ 4 | 10 | 56 | <15% | 836 |
| 5 | 6 plus 2 @ 4 | 10 | 56 | <15% | 831 |
| 6 | 8 | 7 | 56 | <10% | 837 |
| 7 | 8 | 7 | 56 | <10% | 831 |
| B | 10 plus 1 @ 6 | 6 | 56 | <10% | 806 |
| C | 10 plus 1 @ 6 | 6 | 56 | <10% | 824 |

*denotes average value of two examples

### Example 8

Ten different preforms were prepared in which a number of cut plies, each measuring 305 mm×305 mm were assembled and pre-consolidated. The number of plies in the preform ranged from one to ten. Pre-consolidation of each ply was carried out at a temperature of 150 degrees for 3 minutes, then a nip pressure of 1751 N/m (10 pli) to produce a semi-rigid preform. Samples were cut from each preform and tested for flexural modulus. In addition, a single preform ply that was not consolidated was also tested for comparison. The modulus results obtained are summarized in Table 2.

TABLE 2

| # Plies in | |
|---|---|
| Preconsolidated | Modulus |
| Preform | of |
| 2 | Preform |
| (no pre- | (MPa) |
| consolidation) | 365 |
| 1 | 428 |
| 2 | 600 |
| 3 | 834 |
| 4 | 669 |
| 5 | 621 |
| 6 | 510 |
| 7 | 359 |
| 8 | 207 |
| 9 | 214 |
| 10 | 179 |

The modulus data in Table 2 shows that pre-consolidation of between two to six plies into a preform provides sufficient flexural modulus (stiffness) to the preform to permit final lamination without excessive fabric layer movement and, hence, wrinkles.

1. A method of manufacturing a composite laminate comprising the steps of:
(a) cutting a plurality of ply shapes from prepreg sheet stock,
(b) stacking, in the desired order, said prepreg ply shapes to form a subassembly of from 2 to 8 cut plies, said subassembly further comprising at least 2 different ply shapes,
(c) pre-consolidating the subassembly at a temperature of from 120° C. to 180° C. and a pressure of from 175 N/m to 3500 N/m for between 1 to 6 minutes to form a semi-rigid preform,
(d) assembling a plurality of semi-rigid preforms into a mold, and
(e) consolidating said plurality of preforms at a temperature of from 105° C. to 190° C. and a pressure of from 0.034 MN/m² to 55 MN/m² for between 1 to 40 minutes to form a composite laminate,
wherein said prepreg plies further comprise
(i). from 70 to 92% by weight of a fabric made from continuous yarn having a tenacity of at least 20 grams per dtex and a modulus of at least 550 grams per dtex, and
(ii) from 8 to 30% by weight of a thermoplastic matrix polymer comprising a blend of elastomeric block copolymers and polyethylene copolymers.

2. The method of claim 1, wherein the continuous yarns of the prepreg are made of filaments made from a polymer selected from the group consisting of polyamides, polyolefins, polyazoles, and mixtures thereof.

3. The method of claim 2, wherein the continuous yarns are made of filaments made from para-aramid polymer.

4. The method of claim 1, wherein the matrix polymer comprises from 50 to 75 weight percent of polyethylene copolymer and from 25 to 50 weight percent of elastomeric block copolymer.

5. A composite laminate made by the method of claim 1.

6. A helmet formed from the composite laminate of claim 5.
